(19) United States
(12) Patent Application Publication
(10) Pub. No.: US 2010/0213227 A1
(43) Pub. Date: Aug. 26, 2010

(54) Cup holder

(75) Inventors: Yasuhiro Kodama, Aichi-ken (JP); Hiroshi Zushi, Aichi-ken (JP); Makoto Okada, Aichi-ken (JP); Tomohiro Ishida, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 12/656,325

(22) Filed: Jan. 26, 2010

(30) Foreign Application Priority Data
Feb. 25, 2009 (JP) 2009-042122

(51) Int. Cl. B60R 7/00

(52) U.S. Cl. 224/400

(57) ABSTRACT

A cup holder includes a holder body, a supporter, an urger, and an inhibitor. The holder body has an accommodation space into which a container is inserted. The supporter is disposed rotatably to the holder body. The urger urges the supporter to rotate upward. The inhibitor is made of an elastic body, and inhibits the supporter from rotating upward and then retains the supporter at a standard position. The inhibitor has a retaining portion. The retaining portion of the inhibitor not only retains the supporter at the standard position by inhibiting the supporter from rotating upward by means of coming into contact with the supporter, but also enables the supporter to rotate more upward beyond the standard position when the supporter exerts a pressing force to the inhibitor to make the inhibitor undergo elastic deformation.

### INCORPORATION BY REFERENCE

The present invention is based on Japanese Patent Application No. 2009-42,122, filed on Feb. 25, 2009, the entire contents of which are incorporated herein by reference.

### BACKGROUND OF THE INVENTION

1. Field of the Invention

The present invention relates to a cup holder, which is disposed in automotive passenger rooms. More specifically, it relates to a cup holder, which comprises an accommodation space and a supporter being capable of supporting a side face of a container that is inserted into the accommodation space.

2. Description of the Related Art

Automobiles are equipped with a cup holder for holding beverage containers stably in the passenger room. Some of the cup holders are provided with a supporter that can support a side face of containers being inserted into the cup holders' accommodation space.

FIG. 7 illustrates a conventional cup holder that is provided with such a supporter. The cup holder 500 comprises a holder body 501, supporters 502, and an urger 503. The holder body 510 has accommodation spaces 510 into which a container is inserted respectively. The supporters 502 are installed to the holder body 501 rotatably in the up/down direction. The urger 503 urges the respective supporters 502 so as to rotate upward.

The supporters 502 have a leading-end supporting portion 502a, and a base-end inhibiting portion 502b, respectively. The leading-end supporting portion 502a is capable of supporting a side face of a container that is inserted into one of the accommodation spaces 510. The base-end inhibiting portion 502b comes in contact with a retaining portion 501a of the holder body 501, and thereby inhibits the supporters 502a from rotating upward. That is, the supporters 502, which are always urged to rotate upward by the urger 503, are inhibited from rotating upward, because the base-end inhibiting portion 502b of the supporters 502 comes in contact with the holder body 501's retaining portion 501a. Thus, the supporters 502 are retained at a standard position, respectively, where the leading-end supporting portion 502a advances into the cup holder 500's accommodation spaces 510 by a predetermined magnitude, respectively.

In the conventional cupholder 500, the leading-end supporting portion 502a of one of the supporters 502, which is retained at the standard position, supports the upper section of a minor-diameter container “CS” when the minor-diameter container “CS” is inserted into one of the holder body 501's accommodation spaces 510, as shown in the left side of FIG. 7. On the other hand, when a major-diameter container “CL” whose diameter is larger than that of the minor-diameter container “CS” is inserted into one of the accommodation spaces 510, the leading-end supporting portion 502a of one of the supporters 502 supports a lower section of the major-diameter container “CL”, because the leading-end supporting portion 502a is pressed and then rotated downward by the bottom face of the major-diameter container “CL” as the major-diameter container “CL” is inserted into one of the accommodation spaces 510.

However, a major-diameter container “CLT” may have a constricted section “T”, which extends in the circumferential direction, in proximity to the bottom. When the major-diameter container “CLT” is inserted into another one of the holder body 501's accommodation spaces 510 as shown in the right side of FIG. 7, another one of the supporters 502 first rotates downward because it is pressed by the bottom face of the major-diameter container “CLT” whose diameter is larger than the diameter of the constricted section “T”, and then the supporter 502 rotates upward as the accommodation of the major-diameter container “CLT” into the accommodation space 510 goes on. Eventually, the supporter 502 might possibly support the constriction section “T” of the major-diameter container “CLT” with the leading-end supporting portion 502a.

When a user pulls the major-diameter container “CLT” from out of the accommodation space 510, it might be difficult for the user to remove the container “CLT” from out of the accommodation space 510 because the supporter 502's leading-end supporting portion 502a might be hooked to a lower face of the major-diameter container “CLT” whose diameter is larger than that of the constricted section “T”. Under the circumstances, when the user tries to pull out the container “CLT” forcibly, the holder body 501's retaining portion 501a, or the supporter 502's base-end inhibiting portion 502b should have been damaged because the supporter 502 might possibly have rotated upward beyond the standard position.

Hence, a cup holder as disclosed in Japanese Unexamined Patent Publication (KOKAI) Gazette No. 2006-51,908 has been known. As illustrate in FIG. 8, such a conventional cup holder 600 comprises a holder body 601 that is provided with a guide slot 605 as well as a first urging spring 604. The guide slot 605 supports a supporter 602's rotary shaft 602c slidably therein. The first urging spring 604 urges the rotary shaft 602c of the supporter 602 upward.

The guide slot 605 is formed as an arc shape whose center is placed at the holder body 601's retaining portion 601a, and that extends in the up/down direction. Note that a second urging spring 603 urges the supporter 602 so as to rotate upward, and that the urging force of the first urging spring 609 is set up so as to be greater than the urging force of the second urging spring 603.

In the thus constructed conventional cup holder 600, the first urging spring 604 exerts the urging force to the supporter 602 so that the supporter 602's rotary shaft 602c is positioned at the guide slot 605's top end when no container is inserted into the accommodation space 610, and simultaneously the second urging spring 603 exerts the urging force to the supporter 602 so that the supporter 602's leading-end supporting portion 602a rotates upward and then the supporter 602's base-end inhibiting portion 602b comes in contact with the holder body 601's retaining portion 601a. Thus, the supporter 602 is retained at a standard position where the leading-end supporting portion 602a has advanced into the holder body 601's accommodation space 610 by a predetermined magnitude.

Let us think where the above-described conventional cup holder 600 holds a major-diameter container “CLT” that has a constricted section “T”, which extends circumferentially, in the vicinity of the container bottom in one of the accommodation spaces 610 and then a user tries to pull the major-diameter container “CLT” from out of the accommodation space 610. If the leading-end supporting portion 602a of one of the supporters 602, which has rotated downward to be at a downwardly-pressed position, hooks to the constricted section “T” of the major-diameter container “CLT” so that a forcible or unbearable force, which acts onto the supporter 602, becomes greater than the urging force of the first urging spring 604, the rotary shaft 602c of the supporter 602 moves downward along the guide slot 605 of the holder body 601. Accordingly, the supporter 602 rotates about the end 601b of the holder body 601's retaining portion 601a, and thereby the supporter 602's leading-end supporting portion 602a rotates more upward beyond the standard position. Consequently, the conventional cup holder 600 shown in FIG. 8 enables the user to remove the major-diameter container “CLT” with the constricted section “T” from out of the accommodation space 610.

However, it is not possible even for the conventional cup holder 600 that is constructed as described above to inhibit the end 601b of the holder body 601's retaining portion 601a and the contact between the end 601b and the supporter 602 from wearing out that results in their damages, because the supporter 602 rotates about the end 601b of the retaining portion 601a.

Moreover, the conventional cup holder 600 shown in FIG. 8 comprises a complicated structure. That is, in order to rotate the leading-end supporting portion 602a of the supporter 602 more upward beyond the standard position, the holder body 601 is provided not only with the guide slot 605 but also with the first urging spring 609 for urging the rotary shaft 602c of the supporter 602 upward. Therefore, it is not possible to secure or even ensure good production efficiency because it takes a lot of time and labor in manufacturing and assembling these component parts.

### SUMMARY OF THE INVENTION

The present invention has been developed in view of the aforementioned circumstances. It is therefore an object of the present invention to provide a cup holder, which comprises a simple structure that not only enables a user to pull out even a container having a constricted section smoothly, which but also makes it possible to keep its component parts, such as the holder body and supporter, from being damaged.

Hereinafter, various means, which can be employed suitably for achieving the objectives, will be described while referring to their operations and advantageous effects additionally, if needed.

A cup holder according to the present invention comprises:

a holder body having an accommodation space which opens upward, and into which a container is inserted;

a supporter having a leading-end supporting portion and a base-end inhibiting portion, the supporter being disposed rotatably to the holder body so that the leading-end supporting portion rotates upward and downward about the base-end inhibiting portion that serves as a rotary axial center, thereby making the leading-end supporting portion advanceable and retractable within the accommodation space of the holder body;

an urger for urging the supporter to rotate upward;

an inhibitor being made of an elastic body, the inhibitor being for inhibiting the supporter from rotating upward and then retaining the supporter at a standard (or neutral) position where the leading-end supporting portion of the supporter advances into the accommodation space of the holder body by a predetermined magnitude; and

the inhibitor having a retaining portion not only being for retaining the supporter at the standard position by inhibiting the supporter from rotating upward by means of coming into contact with the base-end inhibiting portion of the supporter, but also being for enabling the supporter to rotate more upward beyond the standard position when the base-end inhibiting portion of the supporter exerts a pressing force to the inhibitor to make the inhibitor undergo elastic deformation.

The coup holder according to the present invention can support the upper section of a minor-diameter container, for instance, which is inserted into the accommodation space of the holder body, with the leading-end supporting portion of the supporter that is placed at the standard position. On the other hand, when a major-diameter container whose diameter is larger than the minor-diameter container's diameter is inserted into the accommodation space instead of the minor-diameter container, the bottom face of the major-diameter container presses down the supporter to rotate downward against the urger's urging force as the major-diameter container is inserted into the accommodation space, because the supporter interferes with the major-diameter container's bottom face. Then, the urger's urging force works as a force to rotate the thus pressed-downward supporter upward, and then brings the leading-end inhibiting portion into contact with a lower side face of the major-diameter container that is fitted into the accommodator container. Consequently, the present cup holder can support the major-diameter container's lower section with the leading-end supporting portion of the supporter.

On the other hand, in the case where a major-diameter container that has a circumferentially-extending constricted section in the proximity of the container's lower section is inserted into the accommodation space of the holder body, the leading-end supporting portion of the supporter, which has rotated downward to be at a downwardly-pressed position, might possibly hook to the major-diameter container's constricted section when a user tries to pull the major-diameter container from out of the accommodation space. If the supporter's leading-end supporting portion should have hooked to the major-diameter container's constricted section, the supporter rotates upward as the user removes the major-diameter container from out of the accommodation space, and then the supporter tries to rotate more upward beyond the standard position.

Under such circumstances, the base-end inhibiting portion of the supporter exerts a pressing force to the inhibitor and then the inhibitor undergoes elastic deformation in the cup holder according to the present invention, because the inhibitor, which comes in contact with the base-end inhibiting portion of the supporter in order to retain the supporter at the standard position, is made of an elastic body. Accordingly, the thus elastically-deforming inhibitor of the present cup holder enables the supporter to rotate upward furthermore beyond the standard position.

Consequently, the supporter rotates more upward beyond the standard position while the leading-end supporting portion is being hooked to the constricted section of the major-diameter container. Therefore, the cup holder according to present invention enables a user to remove the major-diameter container having the constricted section from out of the accommodation space of the holder body smoothly and with ease. Moreover, since it is not at all the case that the supporter is rotated upward forcibly on this occasion, the present cup holder makes it possible to keep the contact between the supporter and the inhibitor from wearing out to result in their damages.

Moreover, the cup holder according to the present invention comprises such a simplified construction that enables the supporter to rotate upward furthermore beyond the standard position by means of making the inhibitor of an elastic body. Accordingly, unlike the complicated structure disclosed in Japanese Unexamined Patent Publication (KOKAI) Gazette No. 2006-51,908, no guide slot 605 and first urging spring 604 for urging the supporter 602's rotary shaft 602c are required at all. Consequently, the present cup holder makes it possible to save the time and labor in manufacturing and assembling its component parts. Thus, it is feasible for manufacturers of cup holders to secure favorable production efficiency for the manufacture of the present cup holder.

In the cup holder according to the present invention, it is preferred that the inhibitor can undergo elastic restoration, thereby returning the supporter, which has rotated upward beyond the standard position, to the standard position.

The above-described first preferable means or setting makes the inhibitor undergo elastic restoration when the retaining portion of the inhibitor comes not to receive the pressing force from the base-end inhibiting portion of the supporter. Accordingly, the supporter, which has rotated upward beyond the standard position, returns to the standard position naturally or of itself. Consequently, after a user has removed a major-diameter container having a constricted section from out of the accommodation space of the holder body, it is not needed for the user to put the supporter, which has rotated upward beyond the standard position, back to the standard position using his or her hand or fingers.

In the cup holder according to the present invention, it is preferred that the inhibitor can be made of a plate spring which comprises a flat-plate portion and an inclined inhibiting portion being disposed at a predetermined angle to the flat-plate portion; and the inclined inhibiting portion can make the retaining portion of the inhibitor.

The above-described second preferable means or setting makes it possible to manufacture the inhibitor with a predetermined shape highly accurately and easily, that is, it is possible for the manufacturers of cup holders to set up the angle of the inclined inhibiting portion to the flat-plate portion and a length of the inclined inhibiting portion by press working, for instance, with high accuracy and with ease. Moreover, the inhibitor exhibits improved durability because the plate spring is strong against repetitive deformations.

Note that it is needless to say that it is feasible to form the inclined inhibiting portion by performing a single bending operation to the flat-plate portion of the plate spring. However, it is possible to adjust or control the separation or interval between the flat-plate portion and the inclined inhibiting portion by providing a plurality of bending or flexural points.

In the second preferable means or setting that is directed to the cup holder according to the present invention, it is desirable that the base-end inhibiting portion of the supporter can have a cam shape whose center makes the rotary axial center of the supporter's leading-end supporting portion, and which has a top that is disposed to separate away from the rotary axial center most; and the top of the cam shape can be directed upward obliquely along the inclined inhibiting portion of the inhibitor.

In the above-described more desirable version of the second preferable means or setting, the cam shape of the supporter's base-end inhibiting portion has a top that is disposed to separate away from the rotary axial center most, and the cam shape's top is directed upward obliquely along or in parallel with the inclined inhibiting portion of the inhibitor. Accordingly, the top of the cam-shaped base-end inhibiting portion approaches the inhibitor's inclined inhibiting portion as the supporter rotates more upward beyond the standard position. Consequently, it is possible to make the inhibitor undergo elastic deformation in such a direction that it separates away from the rotary axial center because the base-end inhibiting portion exerts the pressing force, which becomes greater gradually, onto the inhibitor.

Moreover, when the supporter has rotated more upward beyond the standard position and then the supporter's base-end inhibiting portion comes not to exert the pressing force to the inhibitor's retaining portion, the inhibitor undergoes elastic deformation to recover the original shape. Accordingly, the inhibitor applies an elastic force to a lower section of the supporter's cam-shaped base-end inhibiting portion that is below the cam-shaped base-end inhibiting portion's top. The thus applied elastic force acts as a rotary force that rotates the supporter's cam-shaped base-end inhibiting portion downward. Consequently, it is possible to return the supporter, which has rotated more upward beyond the standard position, to the standard position.

In the above-described more desirable version of the second preferable means or setting that is directed to the cup holder according to the present invention, it is much more desirable that the supporter can have a dog-leg-shaped cross section whose bent point makes the rotary axial center of the supporter's leading-end supporting portion, in which one of the opposite ends makes the supporter's leading-end supporting portion, and in which another one of the opposite ends makes the top of the cam shape of the supporter's base-end inhibiting portion.

In the more desirable version of the second preferable means or setting, the top of the supporter's cam-shaped base-end inhibiting portion approaches the inhibitor's inclined inhibiting portion as the supporter rotates more upward beyond the standard position, and then the top of the cam-shaped base-end inhibiting portion comes in contact with the inclined inhibiting portion eventually. Under the circumstances, if the supporter should have rotated upward furthermore, the top of the cam-shaped base-end inhibiting portion might come off from the inclined inhibiting portion. As a result, the supporter might not be able to return naturally or of itself to the standard position.

In view of above, the supporter has a dog-leg-shaped cross section whose bent portion makes the rotary axial center of supporter's leading-end supporting portion in the much more desirable version of the second preferable means or setting. Accordingly, even if the supporter should have rotated upward beyond the standard position greatly, the top of the supporter's cam-shaped base-end inhibiting portion is less likely to come off from the inhibitor's inclined inhibiting portion. That is, even if the supporter should have rotated upward beyond the standard position greatly, the supporter can return to the standard position naturally or of itself. Consequently, a user can pull a major-diameter container having a constricted section from out of the holder body's accommodation space more smoothly and easily.

In the above-described more desirable version of the second preferable means or setting that is directed to the cup holder according to the present invention, it is much more desirable that the inhibitor can be made of a plate spring whose supporting points make the inhibitor's longitudinal opposite ends.

Plate springs exhibit such a characteristic that they produce greater elastic forces in proportion to deformations when the opposite ends make supporting points than when one of the opposite ends makes a fixed end and the other one of them makes a free end. When the longitudinal opposite ends of the inhibitor make supporting points, it is therefore feasible to form the inhibitor, which is made of a plate spring, of a material whose plate thickness is thinner, or a material which exhibits lower elastic coefficient, than the case where one of the inhibitor's longitudinal opposite ends makes a fixed end and the other one makes a free end.

In the above-described more desirable version of the second preferable means or setting that is directed to the cup holder according to the present invention, it is much more desirable that the inhibitor can be made of a plate spring whose fixed end makes one of the inhibitor's longitudinal opposite ends, and whose free end makes another one thereof.

The much more desirable version of the second preferable means or setting comprises the inhibitor which is fixed at one of the opposite ends alone, and which is neither fixed nor supported at another one of the opposite ends. Accordingly, it is not needed to provide the other one of the inhibitor's opposite ends with any structure for fixing or supporting the inhibitor proper. Consequently, it is possible to intend to simplify the inhibitor, one of the component parts of the cup holder according to the present invention.

Moreover, it is feasible to apply the much more desirable version of the second preferable means or setting to a cup holder that comprises a structure in which the supporter is exposed in the uppermost section of the holder body when one of the inhibitor's opposite ends, for example, the lower end, makes a fixed end, because it is not necessary to dispose any structure for supporting the inhibitor itself at the other one of the inhibitor's opposite ends, namely, at the upper end. In such a cup holder, it is possible to place the supporter at a much higher position. Accordingly, the supporter can support a container, which is to be inserted into the holder body's accommodation space, at the much upper section. Consequently, the thus supported container exhibits enhanced stability.

In addition, it is feasible to apply the much more desirable version of the second preferable means or setting to a cup holder that comprises a structure whose holder body's accommodation space is free of any inner wall surface that is disposed below the supporter when one of the inhibitor's opposite ends, for example, the upper end, makes a fixed end. The resulting cup holder enables the designers of cup holders to keep down the depth of the accommodation space as small as possible. Therefore, the designers can embody the cup holder according to the present invention as an accommodable or storable cup holder that is usually put inside a center console so as to disappear from the view of a user in a vehicle passenger room, and which is exposed within the vehicle passenger room on the user's demand, for instance.

The cup holder according to the present invention enables a user to pull out even a container with a constricted section smoothly. Moreover, the present cup holder can keep the holder body and supporter from being damaged, thereby improving their durability. In addition, it is possible for the manufacturers of cup holders to make the present cup holder with ensured good production efficiency because it comprises not only a reduced number of component parts but also a simplified structure.

### BRIEF DESCRIPTION OF THE DRAWINGS

A more complete appreciation of the present invention and many of its advantages will be readily obtained as the same becomes better understood by reference to the following detailed description when considered in connection with the accompanying drawings and detailed specification, all of which forms a part of the disclosure.

FIG. 1 is a perspective diagram for illustrating a cup holder in Example No. 1 according to the present invention.

FIG. 2 is an exploded perspective diagram for illustrating a subassembly of the cup holder in Example No. 1 according to the present invention.

FIG. 3 is a cross-sectional diagram for illustrating how the subassembly of the cup holder operates in Example No. 1 according to the present invention, and is taken in the direction of arrows “3”-“3” designated in FIG. 1, wherein FIG. 3(a) shows circumstances where a supporter is rotating downward from the standard position and FIG. 3(b) shows circumstances where the supporter has rotated upward beyond the standard position.

FIG. 4 is a cross-sectional diagram for illustrating how a subassembly of a cup holder operates in Example No. 2 according to the present invention, wherein FIG. 4(a) shows circumstances where a supporter is rotating downward from the standard position and FIG. 4(b) shows circumstances where the supporter has rotated upward beyond the standard position.

FIG. 5 is a cross-sectional diagram for illustrating how a subassembly of a cup holder operates in Example No. 3 according to the present invention, wherein FIG. 5(a) shows circumstances where a supporter is rotating downward from the standard position and FIG. 5(b) shows circumstances where the supporter has rotated upward beyond the standard position.

FIG. 6 is a cross-sectional diagram for illustrating how a subassembly of a cup holder operates in Example No. 4 according to the present invention, wherein FIG. 6(a) shows circumstances where a supporter is rotating downward from the standard position and FIG. 6(b) shows circumstances where the supporter has rotated upward beyond the standard position.

FIG. 7 is a cross-sectional diagram for illustrating a conventional cup holder, and shows circumstances where a minor-diameter container or a major-diameter container is inserted into one of the conventional cup holder's accommodation spaces and a major-diameter container having a constricted section is inserted into the other one of them.

FIG. 8 is a cross-sectional diagram for illustrating another conventional cup holder that is provided with a function of enabling a supporter for supporting container to rotate upward beyond the standard position.

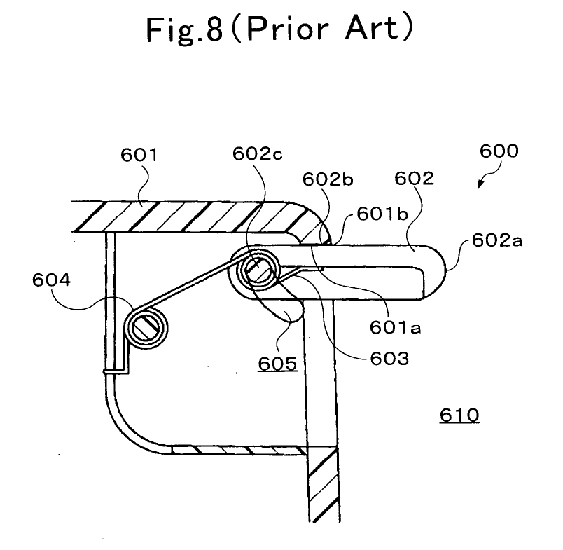

### DETAILED DESCRIPTION OF THE PREFERRED EMBODIMENTS

Having generally described the present invention, a further understanding can be obtained by reference to the specific preferred embodiments which are provided herein for the purpose of illustration only and not intended to limit the scope of the appended claims.

Hereinafter, the cup holders according to examples of the present invention will be described in detail while referring to the drawings.

### EXAMPLES

### (Example No. 1)

### (1) Construction of Cup Holder 1

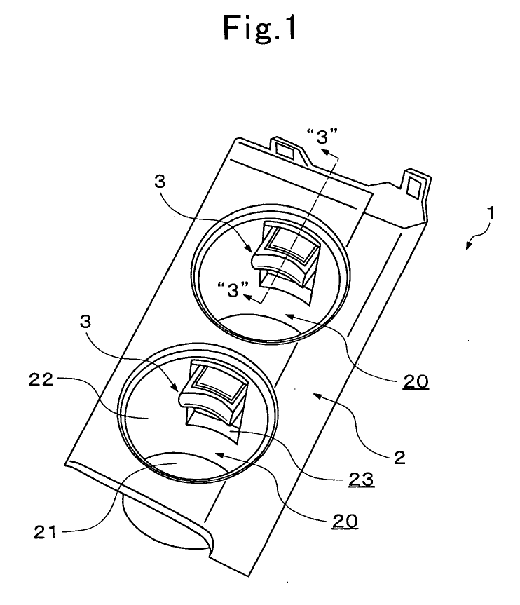

In FIG. 1, there is shown a perspective diagram for illustrating a cup holder 1 according to Example No. 1 of the present invention. As illustrated in FIG. 1, the perspective diagram shows that the cup holder 1 according to the present example comprises a holder body 2, and two subassemblies 3.

The holder body 2 is formed as a box shape, and has two accommodation spaces 20, 20 into which a container is inserted, respectively. Since the respective accommodation spaces 20, 20 are constructed in the same manner with each other, one of the accommodation spaces 20, 20 will be hereinafter described how it is constructed, and descriptions on the other one of them will not be made hereinbelow.

The accommodation space 20 has a bottom face 21, and an inner wall face 22. The bottom face 20 is formed as a circular shape substantially. The inner wall face 22 is formed as a cylindrical shape substantially. The bottom face 21, and the inner wall face 22 have such a diameter that is set up so as to enable them to accommodate a major-diameter container therein, respectively. The accommodation space 20's inner wall face 22 is provided with an accommodation dent 23 that is formed as a rectangular parallelepiped shape.

Each of the accommodation dents 23, 23 of the holder body 2's respective accommodation spaces 20, 20 accommodates each of the subassemblies 3, 3 therein. Since the respective subassemblies 3, 3 comprise the same constituent elements with each other, the constituent elements of one of the subassemblies 3, 3 will be hereinafter described, and descriptions on the constituent elements of the other one of them will not be made hereinbelow.

### (2) Construction of Subassembly 3

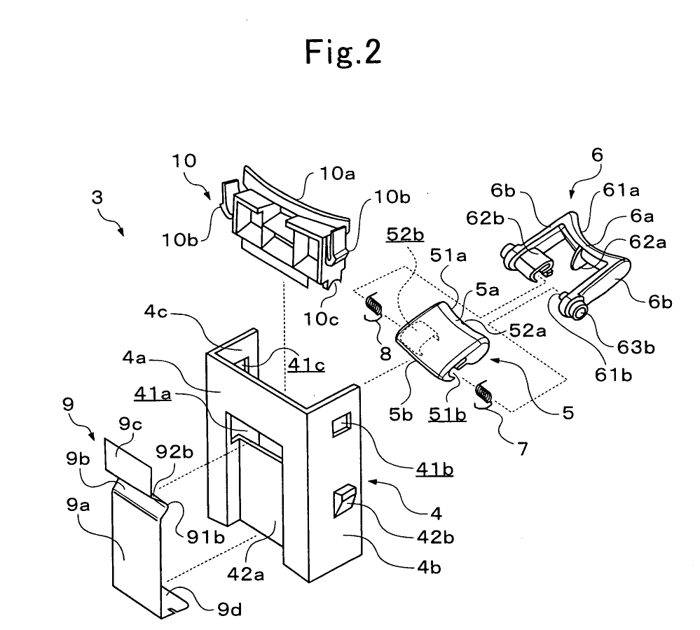

FIG. 2 shows an exploded perspective diagram for illustrating the subassembly 3. As shown in the drawing, the subassembly 3 comprises a case 4, a first supporter 5, a second supporter 6, a first urger 7, a second urger 8, an inhibitor 9, and a retainer 10.

The case 4, the first supporter 5, the second supporter 6, and the retainer 10 are made of an injection-molded product, which is formed of synthetic resin, respectively. The first urger 7, the second urger 8, and the inhibitor 9 are made of a processed metallic product, respectively.

As illustrated in FIG. 2, the case 4 is formed as a letter “U” shape in cross section, and has a first side wall 4a, a second side wall 4b, and a third side wall 4c. The second side wall 4b and third side wall 4c are disposed at the opposite ends of the first side wall 4a so as to face each other. The first side wall 4a is provided with a first installation opening 41a, and an installation dent 42a. The first installation opening 41a is used for installing the inhibitor 9 to the case 4 so that a later-described inclined inhibiting portion 92b of the inhibitor 9 protrudes toward and beyond the front face of the first side wall 4a. Moreover, the installation dent 42a is used for installing a later-described flat-plate portion 9a of the inhibitor 9 by means of fitting.

As shown in FIG. 2, the second side wall 4b is provided with a second installation hole 41b, and the third side wall 4c is provided with a third installation hole 41c. The second installation hole 41b and third installation hole 41c are disposed to face each other in order to install the retainer 10 to the case 4. Moreover, the second side wall 4b is provided with a locking claw 42b on the outer face, and the third side wall 4c is provided with a locking claw 42c (not shown) on the outer face. The locking claw 42b and locking claw 42c engage with locking dents (not shown) that are formed in the inner wall faces of the holder body 2's accommodation dent 23.

As illustrated in FIG. 2, the retainer 10 has an inner wall face 10a, and two engaging protrusions 10b, 10b. The inner wall face 10a makes an arc shape whose radius is equal to that of the accommodation space 20's inner wall face 22. The engaging protrusions 10b, 10b engage with the case 4's second installation hole 41b and third installation hole 41c, respectively. Moreover, the retainer 10 is provided with shaft-retaining portions 10c, 10c. The shaft-retaining portions 10c, 10c are disposed under the engaging protrusions 10b, 10b, which are provided on both opposite side faces of the retainer 10. The shaft-retaining portions 10c, 10c have an inner surface, respectively, which is formed as a semi-arc shape substantially in order to retain an upper section of the second supporter 6's later-described shafts 63b, 63b. The retainer 10 is retained to the case 4 by engaging the retainer 10's engaging protrusions 10b, 10b with the case 4's second installation hole 41b and third installation hole 41c, respectively.

The second supporter 6 serves as a supporter for minor-diameter container, that is, the second supporter 6 can support a minor-diameter container, which is inserted into the holder body 2′ accommodation space 20, at the upper side face. The second supporter 6 is formed as a letter “U” shape. Specifically, the second supporter 6 comprises a second leading-end supporting portion 6a, and paired legs 6b, 6b that extend from the opposite ends of the second leading-end supporting portion 6a. The second leading-end supporting portion 6a is provided with an arc-shaped minor-diameter-container supporting surface 61a on the outer face. Moreover, the second leading-end supporting portion 6a is provided with a rib 62a, which protrudes inward, on the inner face (or back face).

One of the second supporter 6's legs 6b, 6b is provided with a shaft 61b, which protrudes toward the other one of the legs 6b, 6b, on the inner face. The other one of the legs 6b, 6b is provided with a second leading-end inhibiting portion 62b, which protrudes toward the one of the legs 6b, 6b, on the inner face. The second leading-end inhibiting portion 62 is provided with a flat surface (i.e., the claimed second inhibitor surface) on the top face. The legs 6b, 6b are provided with shafts 63b, 63b on the outer face. The shafts 63b, 63b are retained rotatably to bearings (not shown). Note that the bearings are formed on the inner face of the case 4's second side wall 4b, and on the inner face of the third side wall 4c. Moreover, the bearings are made of a substantially semi-arc-shaped inner surface, respectively.

The first supporter 5 serves as a supporter for intermediate-diameter container, that is, the first supporter 5 can support an intermediate-diameter container, which is inserted into the holder body 2′ accommodation space 20. The first holder 5 is formed in such a size as being accommodable or storable inside the second supporter 6's paired legs 6b, 6b. The first supporter 5 is provided with an arc-shaped intermediate-diameter-container holder surface 51a at one of the opposite ends on the outer face of its first leading-end supporting portion 5a. Moreover, the first supporter 5 is provided with a dent 52b at the other one of the opposite ends on the rear face. Note that the second supporter 6's second base-end inhibiting portion 62b can come in and go out of the dent 52b. In addition, the first supporter 5 is provided with a pivotally-supporting opening 51b, which can engage with the second supporter 6's shaft 61b, at the other one of the opposite ends in the side face that faces oppositely to the dent 52b. Furthermore, the first supporter 5's intermediate-diameter-container holder surface 51a is provided with a groove 52a, which can engage with the second supporter 6's rib 62a.

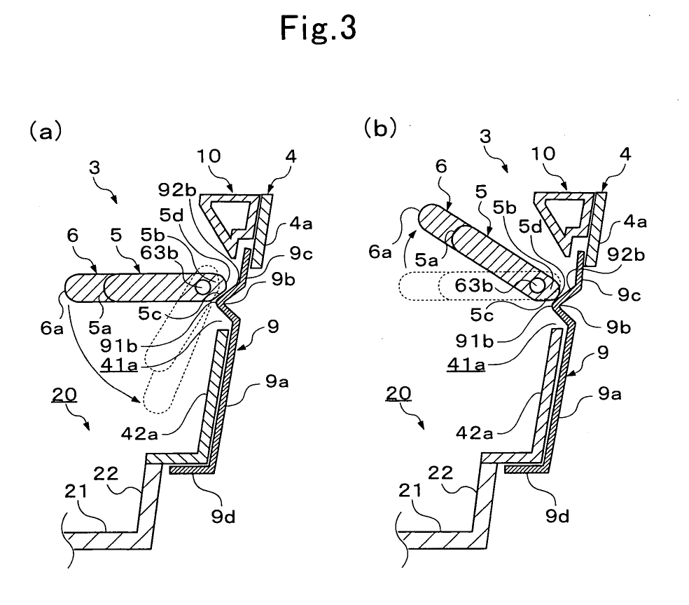

Note that the other one of the first supporter 5's opposite ends makes a base-end inhibiting portion 5b. As illustrated in FIG. 3, the base-end inhibiting portion 5b is formed as a cam shape in which the second supporter 5's shafts 63b, 63b make the center. Moreover, the cam-shaped base-end inhibiting portion 5b has a top 5d. The top 5d is put in place at a position that is most away from the shafts 63b, 63b, and is directed upward obliquely along or in parallel with the inhibitor 9's later-described inclined inhibiting portion 92b that serves as the claimed retainer. In addition, down below from the cam-shaped base-end inhibiting portion 5b's top 5d, the cam-shaped base-end inhibiting portion 5b is provided with an inhibitor flat surface 5c (see FIG. 3) that is directed downward obliquely along or in parallel with the inclined inhibiting portion 92b. The base-end inhibiting portion 5b's inhibitor flat surface 5c comes in contact with the inclined inhibiting portion 92b, thereby inhibiting the first supporter 5 from rotating upward and then retaining the first supporter 5 at a first substantially-horizontal standard position, as shown in FIG. 3(a).

Moreover, the dent 52b of the first supporter 5 makes another or the claimed second retaining portion. Specifically, as illustrated in FIG. 2, the top face of the second supporter 6's second leading-end inhibiting portion 62b, namely, the claimed second inhibitor surface, comes in contact with the inner face of the first supporter 5's dent 52b that serves as another or the claimed second retaining portion, thereby inhibiting the second supporter 6 from rotating upward and then retaining the second supporter 6 at a second substantially-horizontal standard position. Note that, at the second horizontal standard position, the second leading-end supporting portion 6a advances into the holder body 2's accommodation space 20 by a predetermined magnitude, as shown in FIG. 3(a).

Both of the first urger 7 and second urger 8 are made of a torsion spring, respectively. As can be seen from FIG. 2, the first urger 7 is fixed to the retainer 10 at one of the opposite ends, and is fixed to the first supporter 5 at the other one of the opposite ends. The first urger 7 urges the first supporter 5 so that the first supporter 5 rotates upward within the holder body 2's accommodation space 20. The second urger 8 is fixed to the retainer 10 at one of the opposite ends, and is fixed to the second supporter 6 at the other one of the opposite ends. The second urger 8 urges the second supporter 6 so that the second supporter 6 rotates upward within the holder body 2's accommodation space 20.

The inhibitor 9 is made of a plate spring that is press worked to a predetermined shape. Specifically, as illustrated in FIG. 2, the inhibitor 9 comprises a major flat-plate portion 9a, an inflected protruding portion 9b, a minor flat-plate portion 9c, and a bent locking portion 9d. The inflected protruding portion 9b is disposed at the top end of the major flat-portion 9a, is formed as a substantially triangular shape in cross section, and protrudes forward from one of the opposite faces of the major flat-plate portion 9a. The minor flat-plate portion 9c extends from the top end of the inflected protruding portion 9b parallelly to the major flat-plate portion 9a. The bent protruding portion 9d is disposed at the bottom end of the major flat-portion 9a, and is bent forward from the one of the opposite faces of the major flat-plate portion 9a. Moreover, the inflected protruding portion 9b has an inflection top point 91b, and an inclined inhibiting portion 92b that extends upward obliquely from the inflection top point 91b. Note that, in the cup holder according to Example No. 1, the inclined inhibiting portion 92b of the inhibitor 9's inflected protruding portion 9b makes the claimed retainer of the inhibitor 9.

### (3) Assembling Subassembly 3

FIG. 3 illustrates how the subassembly 3 is constructed after the completion of the assembly operations. Note that FIG. 3 is a cross-sectional view that is taken along the arrowheaded lines “3”-“3” in FIG. 1. The subassembly 3 is assembled first in order to complete the cup holder 1 according to Example No. 1.

Specifically, as illustrated in FIG. 2, the inhibitor 9 is installed to the case 4 by fitting the inhibitor 9's major flat-plate portion 9a into the case 4's installation dent 42a from the case 4's back-face side while facing the inhibitor 9's inflected protruding portion 9b the case 4's first installation opening 41a. When being thus installed, the inhibitor 9's inflected protruding portion 9b protrudes from the back-face side of the case 4's first side wall 4a to the front-face side of the first side wall 4a through the first installation opening 41a. Moreover, the inhibitor 9's minor flat-plate portion 9b, which extends upward from the top end of the inflected protruding portion 9c, is retained slidably to the front face of the first side wall 4a that is present above the installation opening 41a. In addition, the inhibitor 9's bent locking portion 9d locks onto the lower face of the bottom wall of the case 4's installation dent 42a, as shown in FIG. 3.

Meanwhile, the first supporter 5, the second supporter 6, the first urger 7, and the second urger 8 are installed to the retainer 10. Specifically, as indicated in FIG. 2, not only the second supporter 6's shaft 61b is inserted into and then is engaged with the first supporter 5's pivotally-supporting opening 51b, but also the second supporter 6's second base-end inhibiting portion 62b is engaged with the first supporter 5's dent 52b. Moreover, the second supporter 6's rib 62a is inserted into and is then engaged with the first supporter 5's groove 52a. Thus, the second supporter 6 is assembled with the first supporter 5.

In the above-described assembled state, the first supporter 5 is retained to the second supporter 6 so that it can rotate upward only with respect to the second supporter 6. Then, while interposing the first urger 7 between the first supporter 5 and the retainer 10, and while interposing the second urger 8 between the second supporter 6 and the retainer 10, the upper sections of the second supporter 6's shafts 63b, 63b are brought into contact with the retainer 10's shaft retaining portions 10c, 10c that are provided under the retainer 10's opposite side faces, and which are formed as a substantially-semi-arc-shaped inner surface.

Moreover, the retainer 10 is installed to the case 4 by engaging the retainer 10's engaging protrusions 10b, 10b respectively with the case 4's second installation hole 41b and third installation hole 41c. When the retainer 10 is fitted to the case 4, the lower sections of the second supporter 6's shafts 63b, 63b come in contact with the case 4's bearings (not shown). Note that the case 4's bearings are provided on the inner face of the case 4's second wall 4b and on the inner face of the third wall 4c, and that the bearings are formed as a substantially-semi-arc-shaped inner surface in the same manner as the retainer 10's shaft retaining portions 10c, 10c. In this way, the second supporter 6's shafts 63b, 63b are held between the retainer 10's shaft retaining portions 10c, 10c and the bearings being formed on the case 4's inner faces, but are retained rotatably between the retainer 10 and the case 4.

As described above, the retainer 10 and case 4 therefore retain the subassembled product of the first supporter 5 and second supporter 6 rotatably.

The first urger 7 urges the first supporter 5 in such a direction that the first leading-end supporting portion 5a rotates upward. Meanwhile, the second urger 8 urges the second supporter 6 in such a direction that the second leading-end supporting portion 6a rotates upward. Note that the second supporter 6 is inhibited from rotating upward beyond the second horizontal standard position because the second supporter 6's second leading-end inhibiting portion 62b has the top face that comes in contact with the inner face of the first supporter 5's dent 52b to serve as the claimed second inhibitor surface.

On this occasion, the second supporter 6 can rotate downward independently so that the second leading-end supporting portion 6a swings downward accordingly. On the contrary, the first supporter 5 is inhibited from rotating downward to go past the second supporter 6 because the dent 52b's inner face comes in contact with the second supporter 6's second leading-end supporting portion 62b, and because the groove 52a's inner face comes in contact with the second supporter 6's rib 62a. That is, not only the second supporter 6 is capable of rotating downward independently, but also the second supporter 6 rotates as being accompanied by the first supporter 5 that rotates downward.

After installing the first supporter 5, the second supporter 6, the first urger 6, the second urger 7, the inhibitor 9 and the retainer 10 to the case 4 to make the subassembly 3 in the above-described manner, the subassembly 3 is accommodated in the accommodation dent 23 of the holder body 2's accommodation space 20. Note that the case 4's locking claws 42b and 42c (not shown) engage with the accommodation dent 23's locking dents (not shown) when the subassembly 3 is accommodated in the accommodation dent 23 completely.

### (4) Operations of Subassembly 3

How the subassembly 3 operates will be hereinafter described with reference to FIG. 3. FIG. 3(a) illustrates how the subassembly 3 appears when the first supporter 5 and second supporter 6 are rotating downward from the first and second horizontal standard positions. Moreover, FIG. 3(b) illustrates how the subassembly 3 appears when the first supporter 5 and second supporter 6 have rotated upward beyond the first and second standard positions.

The first urger 7 and second urger 8 urge the first supporter 5 and second supporter 6 upward, respectively. However, as shown in FIG. 3(a), the first supporter 5 is inhibited from rotating upward and is then retained usually at the first horizontal standard position, because the inhibitor flat surface 5c of the first supporter 5's base-end inhibiting portion 5b comes in contact with the inhibitor 9's inclined inhibiting portion 92b that serves as the claimed retaining portion.

The second supporter 6, which is present at the second horizontal standard position, is capable of supporting an upper section of a minor-diameter container (not shown in FIGS. 1, 2 and 3), for instance, which is inserted into the accommodation space 20 of the cup holder 1's holder body 2, at the second leading-end supporting portion 6a. Moreover, when a user inserts a major-diameter container (not shown in the drawings) whose diameter is greater than that of the minor-diameter container into the accommodation space 20, the bottom face of the major-diameter container presses the first supporter 5 and second supporter 6 downward as the user inserts the major-diameter container into the accommodation space 20, because the first supporter 5's first leading-end supporting portion 5a and the second supporter 6's second leading-end supporting portion 6a interfere with the major-diameter container's bottom face. Then, the first supporter 5 and second supporter 6 rotate downward about the second supporter 6's shafts 63b, 63b against the urging forces that the first urger 7 and second urger 8 exert to them. Note that, in FIG. 3(a), the broken lines indicate positions at which the first supporter 5 and second supporter 6 are placed, respectively, when they have finished rotating downward.

The urging force of the first urger 7 pushes the first leading-end supporting portion 5a of the first supporter 5, which has been thus rotated downward, onto a lower side face of the major-diameter container, which is inserted into the accommodation space 20 of the holder body 2. Likewise, the urging force of the second urger 8 pushes the second leading-end supporting portion 6a of the second supporter 6 onto another lower side face of the major-diameter container. As a result, the first supporter 5, which is pressed to rotate downward, can support a lower section of the major-diameter container, at the first leading-end supporting portion 5a. Moreover, the second supporter 6, which is pressed to rotate downward, can support another lower section of the major-diameter container, at the second leading-end supporting portion 6a.

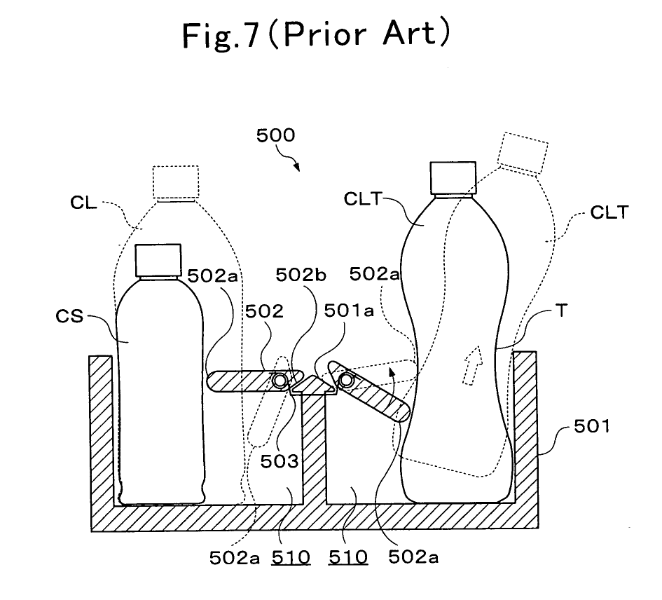

On the other hand, when a user inserts a major-diameter container with a constricted section (not shown in FIGS. 1, 2 and 3) into the accommodation space 20 of the cup holder 1's holder body 2 and then he or she pulls the major-diameter container having a constricted portion from out of the accommodation space 20, the second leading-end supporting portion 6a of the second supporter 6, which is rotated downward about the shafts 63b, 63b to be present at the downwardly-pressed position as shown in the right side of FIG. 7, might possibly be hooked onto the major-diameter container's constricted section.

If the second supporter 6's second leading-end supporting portion 6a should have been hooked onto the major-diameter container's constricted section, the first supporter 5 and second supporter 6 try to rotate more upward beyond the first and second horizontal standard positions as the user removes the constricted major-diameter container from out of the holder body 2's accommodation space 20. FIG. 3(b) illustrates such circumstances where the first supporter 5 and second supporter 6 have rotated more upward beyond the first and second horizontal standard positions.

As described above, the first supporter 5's base-end supporting portion 5b is formed as a cam shape in which the second supporter 6's shafts 63b, 63b make the center. Moreover, the cam-shaped base-end supporting portion 5b has the top 5d that is separated away from the shafts 63b, 63b most, and which is directed upward obliquely in parallel substantially with the inhibitor 9's inclined inhibiting portion 9b serving as the claimed retainer, as illustrated in FIG. 3(a), when the first supporter 5 is placed horizontally, that is, when it is present at the first horizontal standard position. Thus, when the first supporter 5 rotates more upward beyond the first horizontal standard position about the second supporter 6's shafts 63b, 63b as shown in FIG. 3(b), the cam-shaped base-end inhibiting portion 5b applies a gradually enlarging pressing force to the inhibitor 9 as the cam-shaped base-end inhibiting portion 5b's top 5d approaches the inhibitor 9's inclined inhibiting portion 92b.

In this instance, since the cup holder 1 according to Example No. 1 comprises the inhibitor 9 that is made of a plate spring, i.e., the claimed elastic body, the inhibitor 9 undergoes elastic deformation in such a direction that it separates away from the second supporter 6's shafts 63b, 63b when it is subjected to the gradually enlarging pressing force from the first supporter 5's base-end supporting portion 5b. Therefore, the inhibitor 9 that is directed to the cup holder 1 according Example No. 1 makes it possible for the first supporter 5 to rotate more upward beyond the first horizontal standard position. Note herein that, when the inhibitor 9 deforms elastically, the inhibitor 9's minor flat-plate portion 9c slides downward because it is retained slidably on the front face of the case 4's first side wall 4a.

On the contrary, when the inhibitor 9's inclined inhibiting portion 92b, which serves as the claimed retainer, comes not to be subjected to the pressing force that the first supporter 5's base-end supporting portion 5b exerts, the inhibitor 9 undergoes elastic recovery. Accordingly, the inhibitor 9 applies an elastic force to the first supporter 5's cam-shaped base-end inhibiting portion 5b in the section that is present under the top 5d. The resulting elastic force acts as a rotary force for rotating the cam-shaped base-end inhibiting portion 5b downward. Consequently, the first supporter 5, which has rotated more upward beyond the first horizontal standard position, returns naturally or of itself to the first horizontal standard position.

Note that the more upward the first supporter 5 rotates beyond the first horizontal standard position the greater elastic deformation magnitude the inhibitor 9 exhibits because the first supporter 5's base-end supporting portion 5b has the cam shape. As a result, the inhibitor 9 produces an enlarging elastic force that makes the first supporter 5, which has rotated upward, return to the first horizontal standard position naturally or of itself.

### (5) Advantageous Effects of Cup Holder 1

The cup holder 1 according to Example No. 1 effects the following advantages as hereinafter described. Let us consider the case where a user inserts a major-diameter container, which is provided with a circumferentially-extending constricted section adjacent to the lower section, into the accommodation space 20 of the cup holder 1's holder body 2 and then he or she tries to pull the constricted major-diameter container from out of the accommodation space 20 but has hooked the major-diameter container's constricted section onto the second leading-end supporting portion 6a of the cup holder 1's second supporter 6. Even if such is the case, the cup holder 1's inhibitor 9 undergoes elastic deformation because the base-end supporting portion 5b of the cup holder 1's first supporter 5 applies a pressing force to the inhibitor 9. Accordingly, the elastically deforming inhibitor 9 enables the first supporter 5 to rotate more upward beyond the first horizontal standard position. Consequently, the first supporter 5, which thus rotates upward, enables the second supporter 6 as well to rotate more upward beyond the second horizontal standard position. Therefore, it is possible for the user to remove the major-diameter container with a constricted section from out of the accommodation space 20 smoothly and easily.

Moreover, on this occasion, the user does not rotate the first supporter 5 and second supporter 6 upward forcibly at all. As a result, it is possible to restrain not only the contacts between the first supporter 5 and the second supporter 6 but also the contacts between the inhibitor 9 and the first supporter 5 from being worn off. Thus, it is possible to inhibit the following from being damaged: the first supporter 5's base-end inhibiting portion 5b and the inhibitor 9's inclined inhibiting portion 92b, which serves as the claimed retainer, for instance.

In addition, the cup holder 1 according to Example No. 1 comprises the inhibitor 9 that is made of a plate spring, namely, the claimed elastic body. Accordingly, the present cup holder 1 has such a simple construction that the inhibitor 9 enables the first supporter 5 and second supporter 6 to rotate more upward beyond the first and second horizontal standard positions. Consequently, the thus simplified construction makes it possible for the manufacturers of cup holders to save the labor hours for manufacturing the present cup holder 1's component parts as well as the man-hour requirements for the assembly. Therefore, the manufacturers can manufacture the present cup holder 1 with good production efficiency reliably.

### (Example No. 2)

A cup holder according to Example No. 2 comprises a first supporter 205 whose base-end inhibiting portion 205b is constructed differently from the base-end inhibiting portion 5b of the first supporter 5 that is directed to Example No. 1. Since the other constituent parts are constructed in the same manner as those of the cup holder 1 according to Example 1, the descriptions on them will be omitted hereinafter.

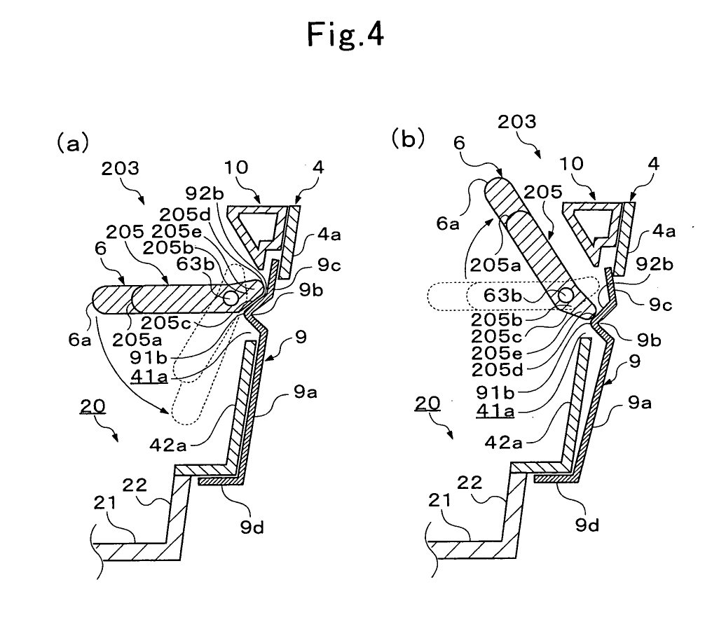

FIG. 4 shows a cross-sectional diagram for illustrating how a subassembly 203 of the cup holder according to Example No. 2 operates. In the cup holder according to Example No. 2, the first supporter 205 has a base-end inhibiting portion 205b that is formed as a cam shape in the same manner as the first supporter 5's base-end inhibiting portion 5b in the cup holder 1 according to Example No. 1. However, in the cup holder according to Example No. 2, the base-end inhibiting potion 205b is distinct from that of the cup holder 1 according to Example No. 1 in that it is provided with an extension 205e that is made by extending the top 5d of the cam-shaped base-end inhibiting portion 5b that is direct to the cup holder 1 according to Example No. 1.

The extension 205e is extended upward obliquely along or in parallel with the inhibitor 9's inclined inhibiting portion 92b when the first supporter 5 is put horizontally, namely, when being placed at the first horizontal standard position as shown in FIG. 4(a). Specifically, the first supporter 205 has a dog-leg shape in cross section. The first supporter 205's cross-sectionally dog-leg shape is provided a bent point between the opposite ends. That is, the bent point is disposed adjacent to the second supporter 6's shafts 63b, 63b. One of the opposite ends makes the first supporter 205's first leading-end supporting portion 205a, namely, one of the opposite ends of the first supporter 205. The other one of the opposite ends makes the cam-shaped base-end leading portion 205b's top 205d, namely, the other one of the opposite ends of the first supporter 205.

As can be appreciated from FIG. 3(b) for illustrating how the cup holder 1 according to Example No. 1 operates, the top 5d of the cam-shaped base-end inhibiting portion 5b might come off from the inclined inhibiting portion 92b if the first supporter 5 should have rotated upward furthermore from the conditions shown in FIG. 3(b). If such is the case, the first supporter 5 might not return to the first horizontal standard position naturally or of itself.

On the contrary, the cup holder according to Example No. 2 comprises the first supporter 205 whose base-end inhibiting portion 205b is provided with the extension 205e. Note that the extension 205e is made by extending the top 5d of the first supporter 5's cam-shaped base-end inhibiting portion 5b that is directed to the cup holder 1 according to Example No. 1. As a result, even if the first supporter 205 should have rotated beyond the first horizontal standard position greatly as illustrated in FIG. 4(b), the cam-shaped base-end inhibiting portion 205b's top 205d is less likely to come off from the inhibitor 9's inclined inhibiting portion 92b.

Therefore, even if the first supporter 205 should have rotated upward beyond the first horizontal standard position greatly, the first supporter 205 can return naturally or of itself to the first horizontal standard position. Thus, it is possible for a user to pull a major-diameter container, which is provided with a constricted section, from out of the holder body 2's accommodation space 20 more smoothly and easily. The cup holder according to Example No. 2 produces the other advantageous effects in the same manner as the cup holder 1 according to Example No. 1 does.

Note that, in the cup holder 1 according to Example No. 1,it is possible to think of preventing the first supporter 5's base-end inhibiting portion 5b from coming off from the inhibitor 9's inclined inhibiting portion 92b by extending the inclined inhibiting portion 92b downward obliquely and then protruding the inflected top point 91b more into the holder body 2's accommodation space 20. However, protruding the inflected top point 91b into the accommodation space 20 greatly might possibly become a factor of hampering the first supporter 5 and second supporter 6 from rotating down below the first and second horizontal standard positions.

### (Example No. 3)

A cup holder according to Example No. 3 comprises the inhibitor 9 that is directed to but constructed differently from that of the cup holder according to Example No. 2. Moreover, the cup holder according to Example No. 3 comprises the case 4 that is similar to that of the cup holder according to Example No. 2 but has a modified structure for installing the differently constructed inhibitor 9 thereto. The other constituent parts will not be described hereinafter because they have the same constructions as those of the cup holder according to Example No. 2.

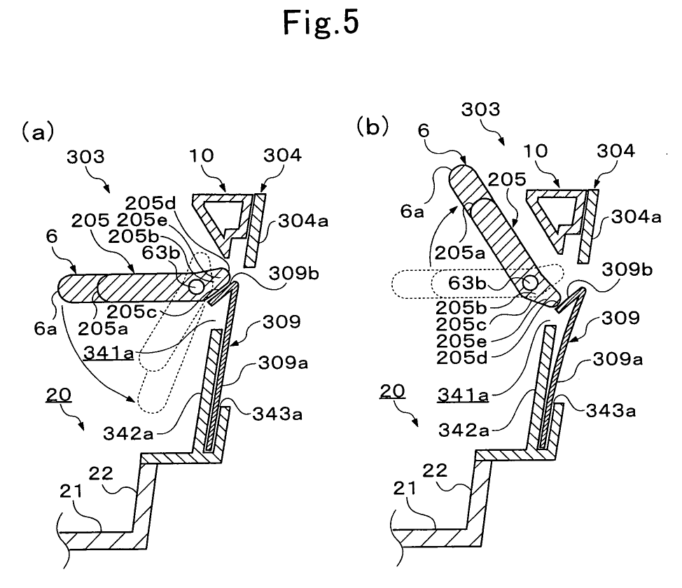

FIG. 5 is a cross-sectional diagram for illustrating the operations of a subassembly 303 that is directed to the cup holder according to Example No. 3. As shown in the drawing, an inhibitor 309 is made of a plate spring. The plate spring has a fixed end that makes the lower end of the inhibitor 309, and a free end that makes the upper end of the inhibitor 309. The inhibitor 309 comprises a flat-plate portion 309a, and a turnover portion 309b. The turnover portion 309b is made by bending and then turning over the upper end of the flat-plate portion 309a toward one of the opposite faces of the flat-plate portion 309a. In the subassembly 303 that is directed to the cup holder according to Example No. 3, the resulting turnover portion 309b constitutes the claimed retainer (or inclined inhibiting portion) of the inhibitor 309.

A case 304 that is directed to the cup holder according to Example No. 3 basically has the same construction as that of the case 4 that is directed to the cup holder 1 according to Example No. 1. That is, a first side wall 304a of the case 304 is provided with a first installation opening 341a, and an installation recess 342a. The first installation opening 341a is adapted for installing the inhibitor 309 to the case 4 so that the turnover portion 309b of the inhibitor 309 protrudes toward the front face of the case 304's first side wall 304a. The installation recess 342a is adapted for installing the flat-plate portion 309a of the inhibitor 309 into the case 4 by fitting. Moreover, the installation recess 342a is provided with an insertion hole 343a. It is possible for an assembly-line worker or robot to insert the flat-plate portion 309a of the inhibitor 309 into the insertion hole 343a from above parallelly to the case 304's first side wall 304a substantially and then lock the flat-plate portion 309a to the insertion hole 343a.

The inhibitor 309 is fixed only at the lower end, namely, the bottom end of its flat-plate portion 309a, and is provided with the upper end that makes a free end. Accordingly, it is not necessary to provide the case 304 with a structure for fastening or supporting the inhibitor 309 at the upper side adjacent to the top end of the inhibitor 309. Consequently, it is possible to simplify the case 304 as well as the inhibitor 309, namely, the constituent parts of the cup holder according to Example No. 3.

Moreover, any structure for fastening or supporting the inhibitor 309 is not required at all for the case 304's upper side above the inhibitor 309's upper end. Therefore, though not being set forth in the present section for describing the cup holder according to Example No. 3, it is possible to apply the subassembly 303, which is directed to the cup holder according to Example No. 3, to cup holders that are constructed so that the first supporter 205 and second supporter 6 are exposed in the uppermost section of the holder body 2.

The thus constructed cup holder according to Example No. 3 makes it possible to put the first supporter 205 and second supporter 6 in place at a higher position than those in the cup holders according to Example Nos. 1 and 2. Accordingly, it is possible for the first supporter 205 and second supporter 6 to support a container, which is inserted into the cup body 2's accommodation space 20, at the much upper section. Consequently, the thus supported container exhibits enhanced stability. The other advantages of the cup holder according to Example No. 3 are the same as those of the cup holders according to Example Nos. 1 and 2.

### (Example No. 4)

A cup holder according to Example No. 4, a modified version of the cup holder according to Example No. 2, comprises the inhibitor 9 with a differently constructed structure, and the case 4 with a differently constructed structure for the installation of the modified inhibitor 9. Since the other constituent parts are constructed in the same manner as those of the cup holder according to Example No. 2, the descriptions on the like constituent parts will not be made hereinafter.

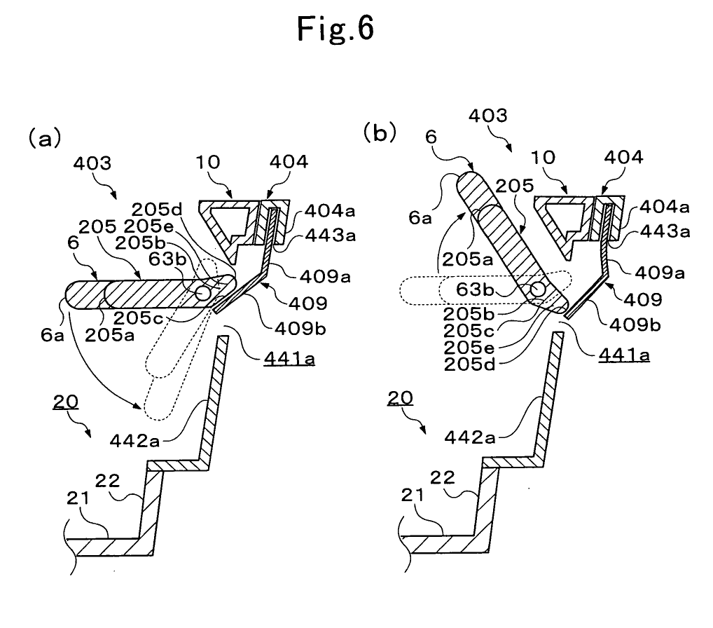

FIG. 6 illustrate how a subassembly 403 that is directed to the cup holder according to Example No. 4 operates in a cross-sectional view. As shown in the drawing, a plate spring makes an inhibitor 409. That is, the plate spring's fixed end, the upper end, makes the upper end of the inhibitor 409, and the free end, the lower end, makes the lower end of the inhibitor 409. Especially, the inhibitor 409 is made of a flat-plate portion 409a, and a bent portion 409b. The bent portion 409b is disposed at the lower end of the flat-portion 409a, and is bent continuously from the lower end of the flat-plate portion 409a obliquely downward to one of the opposite faces of the flat-plate portion 409a. Thus, the subassembly 403 that is directed to the cup holder according to Example No. 4 comprises the modified inhibitor 409 in which the bent portion 409b makes the claimed retainer (or inclined inhibiting portion).

A case 404 that is directed to the cup holder according to Example No. 4 basically comprises the same constituent elements as those of the case 4 that is directed to the cup holder 1 according to Example No. 1. For example, the case 404 comprises a first side wall 404a, which is provided with a first installation opening 441a and a recess 442a. The first installation opening 441a is designed to help an assembly-line worker or robot install the inhibitor 409 to the case 404 so as to protrude the bent portion 409b of the inhibitor 409 toward the front face of the first side wall 404a. The recess 442a is designed to inhibit the leading end of the inhibitor 409's bent portion 409a from protruding into the case 404. Moreover, an insertion hole 443a is formed in the upper section of the case 404's first side wall 404a. Therefore, an assembly-line worker or robot can insert the flat-plate portion 409a of the inhibitor 409 into the insertion hole 443a from below parallelly to the first side wall 404a substantially, and then lock the flat-plate portion 409a to the insertion hole 443a.

Thus, the subassembly 403 that is directed to the cup holder according to Example No. 4 comprises the inhibitor 409 that is fixed at the upper end alone, namely, the flat-plate portion 409a's upper part alone, and whose lower end makes a free end. Accordingly, the subassembly 403 makes it unnecessary to dispose a structure for fastening or supporting the inhibitor 409 at the lower part adjacent to its own lower end. Consequently, the subassembly 403 enables the designers of cup holders td simplify not only the inhibitor 409 but also the case 404, namely, the subassembly 403 enables the designers to make the cup holder according to Example No. 4 of simplified constituent elements.

Moreover, the subassembly 403 that is directed to the cup holder according to Example No. 4 makes it unnecessary to provide the case 404 with a structure for fastening or supporting the inhibitor 409 at the lower side adjacent to the bottom end of the inhibitor 409. Therefore, though not being set forth in the present section for describing the cup holder according to Example No. 4, the subassembly 403 that is directed to the cup holder according to Example No. 4 can be applied to cup holders whose holder body's accommodation space does not have any inner wall face under the first supporter 205 and second supporter 6.

Thus, it is feasible for the designers of cup holders to provide the thus constructed cup holder according to Example No. 4 with the accommodation space 20 whose depth is reduced as much as possible. Therefore, it is possible for the designers to make use of the cup holder according to Example No. 4 in embodying, for instance, an accommodable or storable cup holder that is usually accommodated in a center console so that passengers within the vehicle passenger room cannot see, but which is exposed in the vehicle passenger room, if needed. The cup holder according to Example No. 4 produces the other advantageous effects in the same as the cup holders according to Example Nos. 1 and 2 do.

Note that the cup holder according to the present invention is not limited to the embodying modes according to above-described Example Nos. 1 through 4. It is possible to put the present cup holder into practice in various modes, to which modifications or improvements that one of ordinary skill in the art can carry out are performed, within a range not departing from the scope of the present invention.

The cup holder according to Example Nos. 1 thorough 4 comprise the subassemblies 3, 203, 303 and 403, respectively, which have two supporters: namely, the first supporter 5 or 205 that is provided with a retainer surface for retaining an intermediate-diameter container; and the second supporter 6 that is provided with a retainer surface for retaining a minor-diameter container. However, it is even permissible that the subassemblies 3, 203, 303 and 403 can have only one of the two supporters, for instance.

Moreover, the cup holder according to Example Nos. 1 thorough 4 comprise the inhibitors 3, 309 and 409, respectively, which are made of a plate spring that is constructed variously. However, the inhibitor's structure is not limited to those described above. For example, it is allowable that the inhibitors 3, 309 and 409 can be constructed so that they usually retain a supporter at a standard position; and they do not interfere with the supporter that rotates downward from the standard position; but they enable the supporter to rotate more upward past the standard position. It is more allowable that the inhibitor can comprise such a structure whose elastic restoration makes it possible for the supporter, which has rotated more upward beyond the standard position, to return to the standard position.

In addition, an embodiment mode is described in Examples Nos. 1 through 4 in which a subassembly is integrated by installing a first supporter, a second supporter, a first urger, a second urger, an inhibitor and a retainer to a case and then the resulting integrated subassembly is assembled with a holder body's accommodation space. However, it is also permissible that the first supporter, the second supporter, the first urger, the second urger, the inhibitor and the retainer can be assembled directly with an inner wall face that makes the accommodation space, without using any case.

Having now fully described the present invention, it will be apparent to one of ordinary skill in the art that many changes and modifications can be made thereto without departing from the spirit or scope of the present invention as set forth herein including the appended claims.

What is claimed is:

1. A cup holder, comprising:
a holder body having an accommodation space which opens upward, and into which a container is inserted;
a supporter having a leading-end supporting portion and a base-end inhibiting portion, the supporter being disposed rotatably to the holder body so that the leading-end supporting portion rotates upward and downward about the base-end inhibiting portion that serves as a rotary axial center, thereby making the leading-end supporting portion advanceable and retractable within the accommodation space of the holder body;
an urger for urging the supporter to rotate upward;
an inhibitor being made of an elastic body, the inhibitor being for inhibiting the supporter from rotating upward and then retaining the supporter at a standard position where the leading-end supporting portion of the supporter advances into the accommodation space of the holder body by a predetermined magnitude; and
the inhibitor having a retaining portion not only being for retaining the supporter at the standard position by inhibiting the supporter from rotating upward by means of coming into contact with the base-end inhibiting portion of the supporter, but also being for enabling the supporter to rotate more upward beyond the standard position when the base-end inhibiting portion of the supporter exerts a pressing force to the inhibitor to make the inhibitor undergo elastic deformation.

2. The cup holder according to claim 1, wherein the inhibitor undergoes elastic restoration, thereby returning the supporter, which has rotated upward beyond the standard position, to the standard position.

3. The cup holder according to claim 1, wherein:
the inhibitor is made of a plate spring which comprises a flat-plate portion and an inclined inhibiting portion being disposed at a predetermined angle to the flat-plate portion; and
the inclined inhibiting portion makes the retaining portion of the inhibitor.

4. The cup holder according to claim 3, wherein:
the base-end inhibiting portion of the supporter has a cam shape whose center makes the rotary axial center of the supporter's leading-end supporting portion, and which has a top that is disposed to separate away from the rotary axial center most; and
the top of the cam shape is directed upward obliquely along the inclined inhibiting portion of the inhibitor.

5. The cup holder according to claim 4, wherein the supporter has a dog-leg-shaped cross section whose bent point makes the rotary axial center of the supporter's leading-end supporting portion, in which one of the opposite ends makes the supporter's leading-end supporting portion, and in which another one of the opposite ends makes the top of the cam shape of the supporter's base-end inhibiting portion.

6. The cup holder according to claim 3, wherein the inhibitor is made of a plate spring whose supporting points make the inhibitor's longitudinal opposite ends.

7. The cup holder according to claim 3, wherein the inhibitor is made of a plate spring whose fixed end makes one of the inhibitor's longitudinal opposite ends, and whose free end makes another one thereof.

8. The cup holder according to claim 1, wherein:
the supporter comprises a first supporter for supporting major-diameter container, and a second supporter for supporting minor-diameter container whose diameter is smaller than that of the major-diameter container;
the first supporter having a first leading-end supporting portion for supporting the major-diameter container, and a first base-end inhibiting portion being disposed to come in contact with the retaining portion of the inhibitor;
the second supporter having a second leading-end supporting portion for supporting the minor-diameter container, and a second base-end inhibiting portion being disposed swingably upward and downward not only relatively to the first base-end inhibiting portion of the first retainer but also relatively to the holder body; and
the urger comprises a first urger for swinging the first supporter upward, and a second urger for swinging the second supporter upward.

9. The cup holder according to claim 8, wherein:
the first base-end inhibiting portion of the first supporter is provided with a second retaining portion; and
the second base-end inhibiting portion of the second supporter is provided with a second inhibitor surface that comes in contact with the second retaining portion of the first supporter, thereby inhibiting the second supporter from rotating upward and then retaining the second supporter at a second standard position.
